(19) United States
(12) Patent Application Publication
(10) Pub. No.: US 2015/0208281 A1
(43) Pub. Date: Jul. 23, 2015

(54) METHOD AND DEVICE FOR SUPPORTING SIPTO FOR EACH IP FLOW IN LOCAL NETWORK

(71) Applicant: LG ELECTRONICS INC., Seoul (KR)

(72) Inventors: Taehyeon Kim, Anyang-si (KR); Laeyoung Kim, Anyang-si (KR); Jaehyun Kim, Anyang-si (KR); Hyunsook Kim, Anyang-si (KR)

(73) Assignee: LG ELECTRONICS INC., Seoul (KR)

(21) Appl. No.: 14/411,036

(22) PCT Filed: Jun. 17, 2013
(86) PCT No.: PCT/KR2013/005309

§ 371 Date: Dec. 23, 2014

Related U.S. Application Data
(60) Provisional application No. 61/663,614, filed on Jun. 24, 2012.
(60) Provisional application No. 61/664,696, filed on Jun. 26, 2012.
(60) Provisional application No. 61/665,910, filed on Jun. 29, 2012.

(51) Int. Cl. H04W 28/12; H04W 76/02

(52) U.S. Cl. CPC H04W 28/12; H04W 76/02; H04W 84/045

(57) ABSTRACT

One embodiment of the present invention relates to a method for enabling a network node to support selected IP traffic offload (SIPTO) in a local network of a wireless communication system, and the method for supporting SIPTO comprises the steps of: determining whether or not SIPTO for each IP flow in the local network is applied to a packet data network (PDN) connection associated with a first access point name (APN); and triggering a PDN connection associated with a second APN to a terminal when the SIPTO for each IP flow is applied.

### TECHNICAL FIELD

The present invention relates to a wireless communication system and, more particularly, to a method and apparatus for supporting Selected IP Traffic Offload at Local Network (SIPTO@LN).

### BACKGROUND ART

A wireless communication system may include macro cells for providing large coverage with high transmit power, and micro cells for providing smaller coverage with lower transmit power compared to the macro cells. The micro cell may be called a pico cell, femto cell, Home NodeB (HNB), or Home evolved-NodeB (HeNB). The micro cell may be located, for example, in a shadow area not covered by the macro cell. A user may access a local network, public Internet, private service providing network, etc. through the micro cell.

The micro cells may be classified as described below based on user access restrictions. The first type is Closed Subscriber Group (CSG) micro cells, and the second type is Open Access (OA) or Open Subscriber Group (OSG) micro cells. The CSG micro cells are accessible by specific permitted users while the OSG micro cells are accessible by all users without restriction. In addition, hybrid access type micro cells provide CSG service to users having CSG IDs and allow access but do not provide CSG service to non-CSG subscribers.

### DISCLOSURE

### Technical Problem

An object of the present invention devised to solve the problem lies in a method for supporting per APN and per IP flow SIPTO@LN by a network node.

It is to be understood that both the foregoing general description and the following detailed description of the present invention are exemplary and explanatory and are intended to provide further explanation of the invention as claimed.

### Technical Solution

The object of the present invention can be achieved by providing a method for supporting Selected IP Traffic Offload at Local Network (SIPTO@LN) by a network node in a wireless communication system, the method including determining whether to apply per IP flow SIPTO@LN to a Packet Data Network (PDN) connection associated with a first Access Point Name (APN), and triggering a PDN connection associated with a second APN to a UE upon determining to apply per IP flow SIPTO@LN.

In another aspect of the present invention, provided herein is a network node for supporting Selected IP Traffic Offload at Local Network (SIPTO@LN) by a network node in a wireless communication system, the network node including a transceiver module, and a processor, wherein the processor is configured to determine whether to apply per IP flow SIPTO@LN to a Packet Data Network (PDN) connection associated with a first Access Point Name (APN), and to trigger a PDN connection associated with a second APN to a UE upon determining to apply per IP flow SIPTO@LN.

The following may be commonly applied to the method and the network node.

The determining may be performed based on one or more of location information of the UE, SIPTO capability information, SIPTO permission information, and local configuration information.

The SIPTO permission information may include per IP flow SIPTO permission information at the local network.

The SIPTO permission information may further include per APN SIPTO permission information.

The per APN SIPTO permission information may include SIPTO Prohibited, SIPTO Allowed (excluding SIPTO@LN), SIPTO Allowed including SIPTO@LN, and SIPTO@LN Allowed only.

The local configuration information may include priority information for per APN SIPTO and per IP flow SIPTO.

The triggering of the PDN connection may include transmitting a message including at least one of a cause value and the second APN.

If the UE already has a PDN connection via the local network, the message may indicate that per IP flow SIPTO is enabled using the PDN connection of the UE.

If the UE does not have a PDN connection via the local network, the message may indicate establishment of the PDN connection via the local network to perform per IP flow SIPTO.

The determining may be performed if the UE moves to a preset area.

The determining may be performed upon one of a service request and a PDN request of the UE.

The first APN and the second APN may be different from each other.

The network node may be one of a Mobility Management Entity (MME) and a Serving GPRS (General Packet Radio Service) Support Node (SGSN).

### Advantageous Effects

According to the present invention, since per IP flow SIPTO can be performed depending on the intention of an operator and necessity, efficient traffic distribution may be achieved. In addition, since per APN SIPTO and per IP flow SIPTO can be considered by a network, appropriate traffic distribution may be achieved.

It will be appreciated by persons skilled in the art that the effects that could be achieved through the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 is a view schematically illustrating the architecture of an Evolved Packet System (EPS) including an Evolved Packet Core (EPC);

FIG. 2 is a view illustrating EPS structures in non-roaming and roaming scenarios;

FIG. 3 is a view illustrating exemplary Local IP Access (LIPA) architectures;

FIG. 4 is a flowchart for describing an initial attach operation for a 3rd Generation Partnership Project (3GPP) Packet Data Network (PDN) connection via an Evolved-UMTS (Universal Mobile Telecommunication System) Terrestrial Radio Access Network (E-UTRAN);

FIG. 5 is a flowchart for describing an initial attach operation for a 3GPP PDN connection via a Home (evolved) NodeB (H(e)NB);

FIG. 6 is a flowchart for describing an initial attach operation for a LIPA PDN connection;

FIG. 7 is a view illustrating a control plane for interfaces among a User Equipment (UE), an evolved NodeB (eNB) and a Mobility Management Entity (MME);

FIG. 8 is a view illustrating a control plane for an interface between an MME and a Home Subscriber Server (HSS);

FIG. 9 is a view illustrating a control plane for interfaces among an MME, a Serving-Gateway (S-GW) and a Packet Data Network-Gateway (P-GW);

FIG. 10 is a view illustrating Selected IP Traffic Offload at Local Network (SIPTO@LN);

FIG. 11 is a flowchart of a method for supporting per IP flow SIPTO@LN by a Mobility Management Entity (MME)/Serving GPRS (General Packet Radio Service) Support Node (SGSN)/Mobile Switching Center (MSC) according to an embodiment of the present invention; and

FIG. 12 is a block diagram of a transceiver apparatus according to an embodiment of the present invention.

### BEST MODE

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

Specific terms used for the embodiments of the present invention are provided to help the understanding of the present invention. These specific terms may be replaced with other terms within the scope and spirit of the present invention.

In some instances, to prevent the concept of the present invention from being ambiguous, structures and apparatuses of the known art will be omitted, or will be shown in the form of block diagram based on main functions of each structure and apparatus. Also, wherever possible, like reference numerals denote the same parts throughout the drawings and the specification.

The embodiments of the present invention can be supported by standard documents disclosed for at least one of wireless access systems, Institute of Electrical and Electronics Engineers (IEEE) 802, 3^{rd} Generation Partnership Project (3GPP), 3GPP Long Term Evolution (3GPP LTE), LTE-Advanced (LTE-A), and 3GPP2. Steps or parts that are not described to clarify the technical features of the present invention can be supported by those specifications. Further, all terms as set forth herein can be explained by the standard specifications.

Techniques described herein can be used in various wireless access systems. For clarity, the present disclosure focuses on 3GPP LTE and LTE-A systems. However, the technical features of the present invention are not limited thereto.

Terms used in the following description are defined as follows.
UMTS (Universal Mobile Telecommunication System): 3^{rd} generation mobile communication technology based on a Global System for Mobile Communication (GSM) developed by 3GPP.
EPS (Evolved Packet System): Network system including an Evolved Packet Core (EPC) which is a Packet Switched (PS) core network based on Internet Protocol (IP) and an access network such as LTE or UMTS Terrestrial Radio Access Network (UTRAN), which is evolved from UMTS.
NodeB: Base station of a GSM (Global System for Mobile Communication)/EDGE (Enhanced Data rates for Global Evolution) Radio Access Network (GERAN)/UTRAN, which is installed outdoors and has a coverage corresponding to a macro cell.
eNB (eNodeB): Base station of an LTE network, which is installed outdoors and has a coverage corresponding to a macro cell.
UE (User Equipment): UE can also be referred to as a terminal, a Mobile Equipment (ME), a Mobile Station (MS) or the like. In addition, the UE can be a portable device such as a laptop computer, a mobile phone, a Personal Digital Assistant (PDA), a smartphone or a multimedia device, or a non-portable device such as a Personal Computer (PC) or a vehicle-mounted device.
RAN (Radio Access Network): Unit including a NodeB, an eNodeB and a Radio Network Controller (RNC) for controlling the NodeB and the eNodeB in a 3GPP network, which is present between UEs and a core network and provides a connection to the core network.
HLR (Home Location Register)/HSS (Home Subscriber Server): Database having subscriber information in a 3GPP network. The HSS can perform functions such as configuration storage, identity management and user state storage.
RANAP (RAN Application Part): Interface between nodes (e.g., Mobility Management Entity (MME)/Serving GPRS (General Packet Radio Service) Support Node (SGSN)/Mobile Switching Center (MSC)) configured to control a RAN and a core network.
PLMN (Public Land Mobile Network): Network configured for the purpose of providing mobile communication services to individuals. This network can be configured per operator.
NAS (Non-Access Stratum): Functional layer for signaling and exchanging traffic messages between a UE and a core network in a UMTS protocol stack. Major functions thereof are to support UE mobility and to support a session management procedure for establishing and maintaining an IP connection between a UE and a Packet Data Network Gateway (PDN GW).
HNB (Home NodeB): Customer Premises Equipment (CPE) for providing UTRAN coverage. For details thereof, reference can be made to 3GPP TS 25.467.
HeNodeB (Home eNodeB): CPE for providing Evolved-UTRAN (E-UTRAN) coverage. For details thereof, reference can be made to 3GPP TS 36.300.
CSG (Closed Subscriber Group): Group of subscribers who are permitted to access one or more CSG cells of a Public Land Mobile Network (PLMN) as members of a CSG of a H(e)NB.
CSG ID: Unique identifier for identifying a CSG within a range of PLMN associated with a CSG cell or a CSG cell group. For details thereof, reference can be made to 3GPP TS 23.003.
LIPA (Local IP Access): Access of an IP capable UE via a H(e)NB to another IP capable entity within the same residential/enterprise IP network. LIPA traffic does not traverse a mobile operator's network. 3GPP Rel-10 feature providing access to resources on the Local Network (LN) (e.g., the network located inside the customer's home or enterprise premises) via a H(e)NB.
MRA (Managed Remote Access): Access of a CSG member to an IP capable entity connected to a home based network from outside the home based network. For example, a user located outside a local network can receive user data services from the local network using MRA.
SIPTO (Selected IP Traffic Offload): 3GPP Rel-10 feature allowing the operator to offload of user traffic by selecting a Packet data network GateWay (PGW) residing close to the Evolved Packet Core (EPC) network edge.
SIPTO@LN (SIPTO at Local Network): SIPTO@LN is an enhancement of the Rel-10 SIPTO feature and allows the operator to offload user traffic via the Local Network (LN) inside the customer's premises. In contrast to Rel-10 LIPA, whose aim is to provide access to resources on the local network itself, the SIPTO@LN feature aims at providing access to external networks (e.g., Internet) via the local network (the underlying assumption being that the Local Network eventually has connectivity towards the desired external network).
Per APN SIPTO: SIPTO performed on an APN basis.
Per IP flow SIPTO: SIPTO performed per IP flow. An IP flow to be applied and a preferred PDN are recorded as policy information of a UE and then used for data transmission.
PDN (Packet Data Network) Connection: Logical connection between a UE indicated by a single IP address (e.g., single IPv4 address and/or single IPv6 prefix) and a PDN indicated by an Access Point Name (APN).
LIPA PDN connection: PDN connection for LIPA of a UE connected to a H(e)NB.
LIPA-Permission: This indicates whether an APN is accessible through LIPA.

Hereinafter, a description will be given based on the above-defined terms.

EPC (Evolved Packet Core)

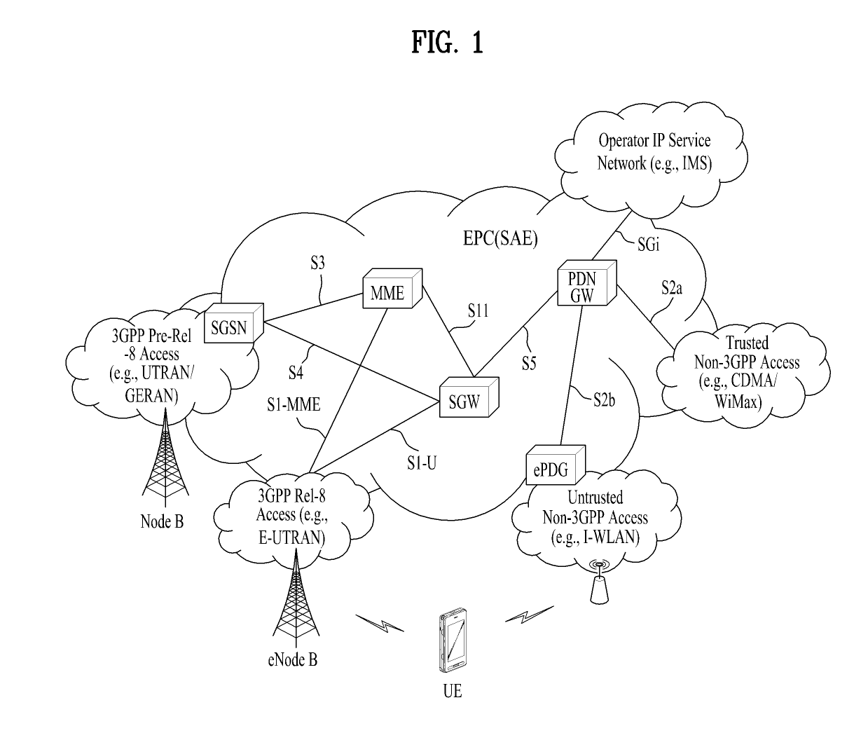

FIG. 1 is a view schematically illustrating the architecture of an Evolved Packet System (EPS) including an Evolved Packet Core (EPC).

The EPC is a fundamental element of System Architecture Evolution (SAE) for improving the performance of 3GPP technologies. SAE corresponds to a study item for determining a network architecture supporting mobility between various types of networks. SAE aims to provide, for example, an optimized packet-based system which supports various radio access technologies based on IP and provides improved data transfer capabilities.

Specifically, the EPC is a core network of an IP mobile communication system for a 3GPP LTE system and may support packet-based real-time and non-real-time services. In the legacy mobile communication system (i.e., 2^{nd} Generation (2G) or 3^{rd} Generation (3G) mobile communication system), the function of a core network is implemented through two distinct sub-domains, e.g., a Circuit-Switched (CS) sub-domain for voice and a Packet-Switched (PS) sub-domain for data. In a 3GPP LTE system evolved from the 3G communication system, the CS and PS sub-domains are unified into a single IP domain. That is, in the 3GPP LTE system, a connection between UEs having IP capability can be established through an IP-based base station (e.g., evolved NodeB (eNodeB)), an EPC and an application domain (e.g., IP Multimedia Subsystem (IMS)). That is, the EPC is an architecture inevitably required to implement end-to-end IP services.

The EPC may include various components. FIG. 1 illustrates some of the components, e.g., Serving Gateway (SGW), Packet Data Network Gateway (PDN GW), Mobility Management Entity (MME), Serving GPRS (General Packet Radio Service) Supporting Node (SGSN) and enhanced Packet Data Gateway (ePDG).

The SGW operates as a boundary point between a Radio Access Network (RAN) and a core network and is an element functioning to maintain a data path between an eNodeB and a PDN GW. In addition, if a UE moves over a region served by an eNodeB, the SGW serves as a local mobility anchor point. That is, packets may be routed through the SGW for mobility in an Evolved-UMTS (Universal Mobile Telecommunications System) Terrestrial Radio Access Network (E-UTRAN) defined after 3GPP Rel-8. Further, the SGW may serve as an anchor point for mobility with another 3GPP network (a RAN defined before 3GPP Rel-8, e.g., UTRAN or GERAN.

The PDN GW (or P-GW) corresponds to a termination point of a data interface directed to a packet data network. The PDN GW may support policy enforcement features, packet filtering and charging support. In addition, the PDN GW may serve as an anchor point for mobility management with a 3GPP network and a non-3GPP network (e.g., untrusted network such as Interworking Wireless Local Area Network (I-WLAN) and trusted network such as Code Division Multiple Access (CDMA) network or WiMax network).

Although the SGW and the PDN GW are configured as separate gateways in the network architecture of FIG. 1, the two gateways may be implemented depending on a single gateway configuration option.

The MME performs signaling and control functions for supporting access for a network connection of a UE, allocation of network resources, tracking, paging, roaming and handover. The MME controls control plane functions related to subscriber and session management. The MME manages a large number of eNodeBs and performs signaling for selection of a conventional gateway for handover to another 2G/3G network. In addition, the MME performs security procedures, terminal-to-network session handling, idle terminal location management, etc.

The SGSN handles all packet data for mobility management of a user to another 3GPP network (e.g., GPRS network) and authentication of the user.

The ePDG serves as a security node for an untrusted non-3GPP network (e.g., I-WLAN or Wi-Fi hotspot).

As described above in relation to FIG. 1, a UE having IP capabilities may access an IP service network (e.g., IMS) provided by an operator via various elements in the EPC based on not only 3GPP access but also non-3GPP access.

FIG. 1 illustrates various reference points (e.g., S1-U and S1-MME). In the 3GPP system, a conceptual link for connecting two functions, which are present in different functional entities of E-UTRAN and EPC, is defined as a reference point. Table 1 shows the reference points illustrated in FIG. 1. Various reference points other than those of Table 1 may also be present depending on the network architecture.

TABLE 1

| Reference | |
|---|---|
| Point | Description |
| S1-MME | Reference point for the control plane protocol between E-UTRAN and |
| | MME |
| S1-U | Reference point between E-UTRAN and Serving GW for the per bearer user |
| | plane tunnelling and inter eNodeB path switching during handover |
| S3 | It enables user and bearer information exchange for inter 3GPP access |
| | network mobility in idle and/or active state. This reference point can be used |
| | intra-PLMN or inter-PLMN (e.g. in the case of Inter-PLMN HO). |
| S4 | It provides related control and mobility support between GPRS Core and the |
| | 3 GPP Anchor function of Serving GW. In addition, if Direct Tunnel is not |
| | established, it provides the user plane tunnelling. |
| S5 | It provides user plane tunnelling and tunnel management between Serving |
| | GW and PDN GW. It is used for Serving GW relocation due to UE mobility |
| | and if the Serving GW needs to connect to a non-collocated PDN GW for |
| | the required PDN connectivity. |
| S11 | Reference point between MME and SGW |
| SGi | It is the reference point between the PDN GW and the packet data network. |
| | Packet data network may be an operator external public or private packet |
| | data network or an intra operator packet data network, e.g. for provision of |
| | IMS services. This reference point corresponds to Gi for 3GPP accesses. |

Among the reference points illustrated in FIG. 1, S2a and S2b correspond to non-3GPP interfaces. S2a is a reference point for providing related control and mobility support between the trusted non-3GPP access and the PDNGW to a user plane. S2b is a reference point for providing related control and mobility support between the ePDG and the PDN GW to the user plane.

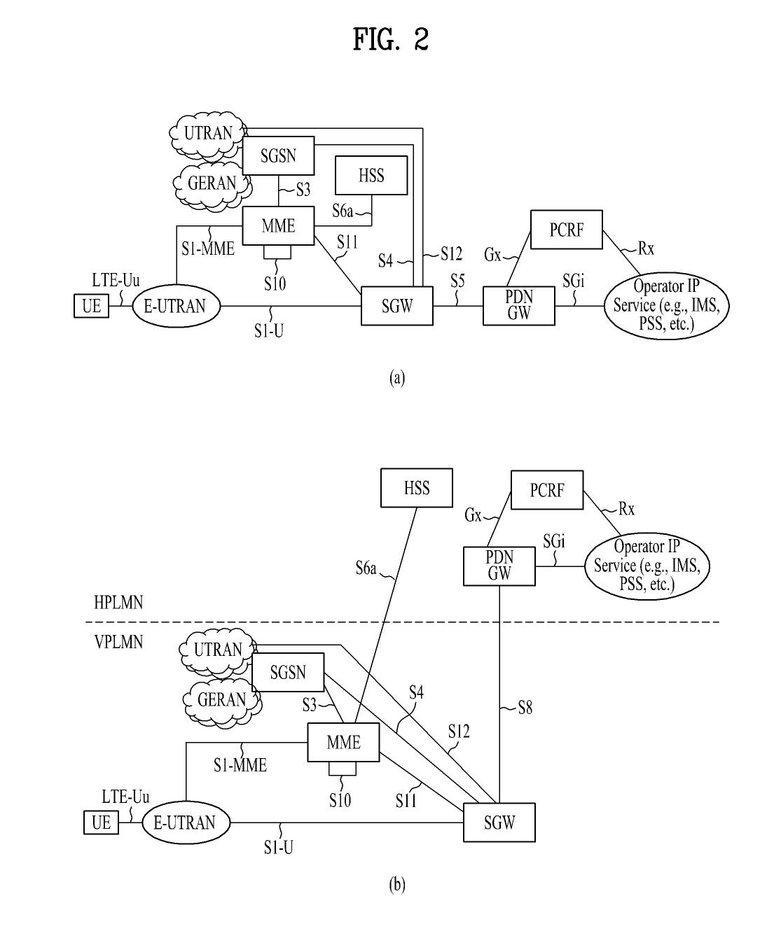

FIG. 2 is a view illustrating EPS structures in non-roaming and roaming scenarios.

FIG. 2 illustrates an HSS and a Policy and Charging Rules Function (PCRF) entity not illustrated in FIG. 1. The HSS is a database having subscriber information within a 3GPP network, and the PCRF is an entity used to control policy and QoS of the 3GPP network.

A description is now given of reference points illustrated in FIG. 2 but not included in Table 1. LTE-Uu is a wireless protocol of an E-UTRAN between a UE and an eNB. S10 is a reference point between MMEs for MME relocation and MME-to-MME data transmission and can be used for intra-PLMN or inter-PLMN. S6a is a reference point between the MME and the HSS and is used for subscription and authentication data transmission. S12 is a reference point between a UTRAN and an SGW and is used for user plane tunneling when a direct tunnel is established. Gx is used to deliver policy and charging rules from the PCRF to a Policy and Charging Enforcement Function (PCEF) in a PDN GW. Rx is a reference point between an Application Function (AF) (e.g., a third party application server) and the PCRF and is used to transmit, for example, session information of an application level from the AF to the PCRF. Although FIG. 2 illustrates IMS for providing multimedia service based on an IP, Packet Switch Streaming (PSS) for providing one-to-one multimedia streaming service using a Session Initiation Protocol (SIP), etc., as an operator IP service, the operator IP service is not limited thereto and a variety of operator IP services are applicable.

FIG. 2(a) corresponds to a system structure in a non-roaming scenario. Although illustrated as separate entities in FIG. 2(a), the SGW and the PDN GW can be configured as one gateway in some cases.

FIG. 2(b) corresponds to a system structure in a roaming scenario. Roaming means to support communication through an EPC in a Visited PLMN (VPLMN) as well as a Home PLMN (HPLMN) of a user. That is, as illustrated in FIG. 2(b), a UE accesses the EPC through the VPLMN and subscription and authentication information, policy and charging rules, etc. are applied by the HSS and the PCRF located in the HPLMN. In addition, the policy and charging rules can be applied by a Visited Policy and Charging Rules Function (V-PCRF) located in the VPLMN. Furthermore, a PDN provided by an operator of the visited network is accessible, and a roaming scenario using IP service of the visited network operator is also applicable.

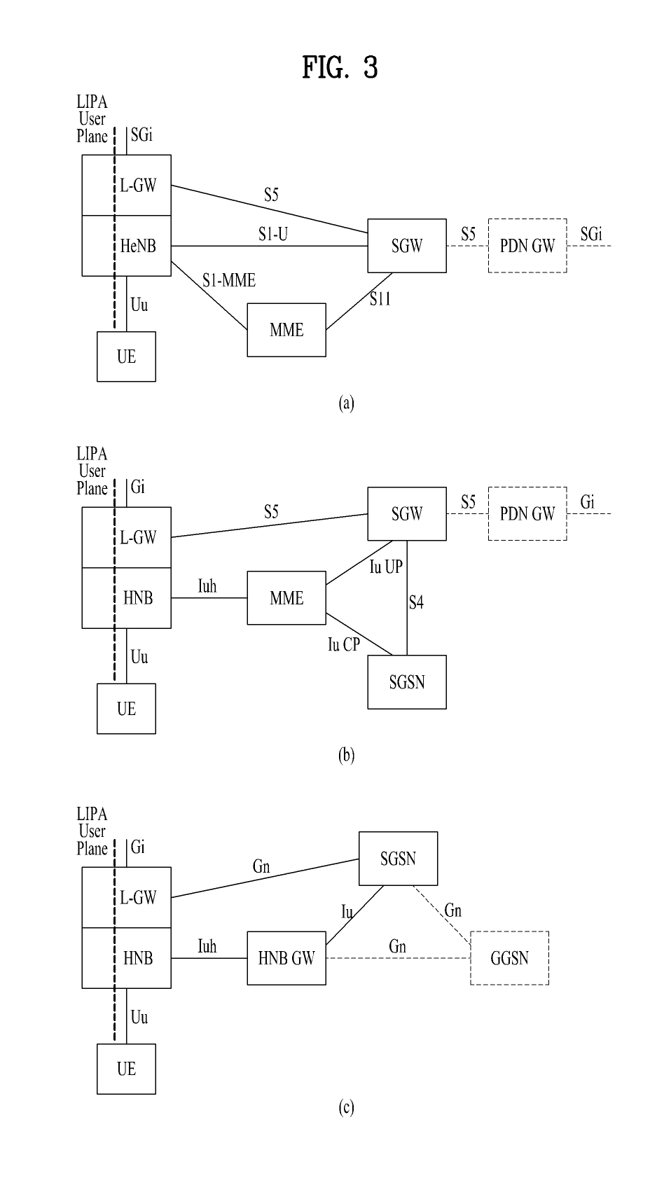

FIG. 3 is a view illustrating exemplary LIPA architectures.

FIGS. 3(a) to 3(c) correspond to examples of the H(e)NB subsystem architecture for LIPA defined in 3GPP Rel-10. Here, the LIPA architecture defined in 3GPP Rel-10 is restricted to a case in which a H(e)NB and a Local-GateWay (LGW) are co-located. However, this is merely an example and the principle of the present invention is also applicable to a case in which the H(e)NB and the LGW are located separately.

FIG. 3(a) illustrates a LIPA architecture for a HeNB using a local PDN connection. Although not shown in FIG. 3(a), a HeNB subsystem may include a HeNB and may optionally include a HeNB and/or an LGW. A LIPA function may be performed using the LGW co-located with the HeNB. The HeNB subsystem may be connected to an MME and an SGW of an EPC through an S1 interface. When LIPA is activated, the LGW has an S5 interface with the SGW. The LGW is a gateway toward an IP network (e.g., residential/enterprise network) associated with the HeNB, and may perform PDN GW functions such as UE IP address assignment, Dynamic Host Configuration Protocol (DHCP) function and packet screening. In the LIPA architecture, a control plane is configured using an EPC but a user plane is configured within a local network.

FIGS. 3(b) and 3(c) illustrate architectures of an HNB subsystem including an HNB and an HNB GW, and a LIPA function may be performed using an LGW co-located with the HNB. FIG. 3(b) illustrates an example of a case in which the HNB is connected to an EPC and FIG. 3(c) illustrates an example of a case in which the HNB is connected to an SGSN. For details of the LIPA architectures of FIG. 3, reference can be made to 3GPP TS 23.401 and TS 23.060.

PDN Connection

A PDN connection refers to a logical connection between a UE (specifically, an IP address of the UE) and a PDN. IP connectivity with a PDN for providing a specific service is required to receive the service in a 3GPP system.

3GPP provides multiple simultaneous PDN connections for access of a single UE simultaneously to multiple PDNs. An initial PDN may be configured depending on a default APN. The default APN generally corresponds to a default PDN of an operator, and designation of the default APN may be included in subscriber information stored in an HSS.

If a UE includes a specific APN in a PDN connection request message, access to a corresponding PDN is attempted. After one PDN connection is established, an additional specific PDN connection request message from the UE should always include the specific APN.

A few examples of IP PDN connectivity enabled by an EPS and defined in 3GPP Rel-10 are as described below (use of non-3GPP access is excluded).

The first example is a 3GPP PDN connection via an E-UTRAN. This is the most typical PDN connection in 3GPP.

The second example is a 3GPP PDN connection via a H(e)NB. Except for admission control for CSG membership due to adoption of a H(e)NB, the 3GPP PDN connection via a H(e)NB is established using a procedure similar to that of a PDN connection.

The third example is a LIPA PDN connection. The LIPA PDN connection is established through LIPA admission control depending on LIPA permission as well as admission control based on CSG membership via a H(e)NB.

A detailed description is now given of initial attach operations for the above three 3GPP PDN connections.

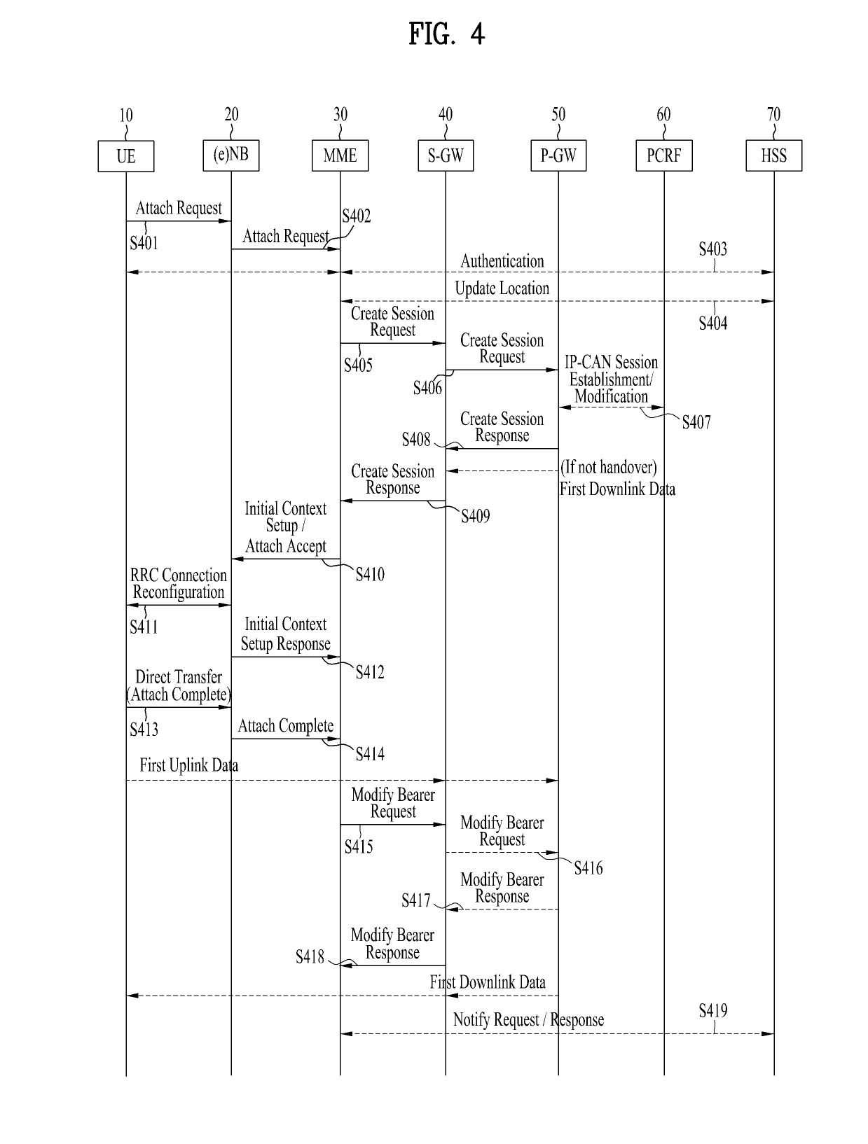

FIG. 4 is a flowchart for describing an initial attach operation for a 3GPP PDN connection via an E-UTRAN.

In steps S401 and S402, a UE 10 may send an attach request message via an eNB 20 to an MME 30. In this case, the UE 10 may also send an APN of a PDN to which a connection is desired, together with the attach request.

In steps S403 and S404, the MME 30 may perform an authentication procedure on the UE 10, and register location information of the UE 10 in an HSS 70. In this operation, the HSS 70 may transmit subscriber information of the UE 10 to the MME 30.

In steps S405 to S409 (step S407 will be described separately), the MME 30 may send a create session request message to an S-GW 40 to establish an EPS default bearer. The S-GW 40 may send the create session request message to a P-GW 50.

The create session request message may include information such as International Mobile Subscriber Identity (IMSI), Mobile Subscriber Integrated Services Digital Network Number (MSISDN), MME Tunnel Endpoint ID (TEID) for Control Plane, Radio Access Technology (RAT) Type, PDN GW Address, PDN Address, Default EPS Bearer QoS, PDN Type, Subscribed Aggregate Maximum Bit Rate (APN-AMBR), APN, EPS Bearer ID, Protocol Configuration Options, Handover Indication, ME Identity, User Location Information (ECGI), UE Time Zone, User CSG Information, MS Info change Reporting Support Indication, Selection Mode, Charging Characteristics, Trace Reference, Trace Type, Trigger ID, Operation Management Controller (OMC) Identity, Max APN Restriction and Dual Address Bearer Flag.

In response to the create session request message, the P-GW 50 may send a create session response message to the S-GW 40, and the S-GW 40 may send the create session response to the MME 30. Through these operations, the S-GW 40 and the P-GW 50 may exchange TEIDs, and the MME 30 may recognize the TEIDs of the S-GW 40 and the P-GW 50.

As an optional procedure, in step S407, a Policy and Charging Rules Function (PCRF) interaction for operator policies may be performed between a Policy and Charging Enforcement Function (PCEF) of the P-GW 50 and a PCRF 60 as necessary. For example, establishment and/or modification of an IP-Connectivity Access Network (CAN) session may be performed. IP-CAN is a term which refers to one of a variety of IP-based access networks, e.g., 3GPP access network such as GPRS or EDGE, Wireless Local Area Network (WLAN) or Digital Subscriber Line (DSL) network.

In step S410, an attach accept message may be transmitted from the MME 30 to the eNB 20. Together with this message, the TEID of the S-GW 40 for UL data may also be transmitted. This message initiates radio resource setup in a RAN period (between the UE 10 and the eNB 20) by requesting initial context setup.

In step S411, Radio Resource Control (RRC) connection reconfiguration is performed. As such, radio resources of the RAN period are set up and a result thereof may be transmitted to the eNB 20.

In step S412, the eNB 20 may transmit an initial context setup response message to the MME 30. A result of radio bearer setup may also be transmitted together with this message.

In steps S413 and S414, an attach complete message may be sent from the UE 10 via the eNB 20 to the MME 30. In this case, the eNB 20 may also send a TEID of the eNB 20 for DL data together with this message. From this time, UL data may be transmitted via the eNB 20 to the S-GW 40 and the UE 10 may transmit UL data.

In steps S415 to S418, a modify bearer request message may be transmitted from the MME 30 to the S-GW 40 and this message may deliver the TEID of the eNB 20 for DL data to the S-GW 40. As optional operations, in steps S416 and S417, the bearer between the S-GW 40 and the P-GW 50 may be updated as necessary. After that, DL data may be transmitted via the eNB 20 to the UE 10.

As an optional operation, in step S419, if APN, ID of PDN GW, etc. should be stored in the HSS 70 to support mobility to a non-3GPP access network, the MME 30 may perform HSS registration using a notify request message and receive a notify response message from the HSS 70 as necessary.

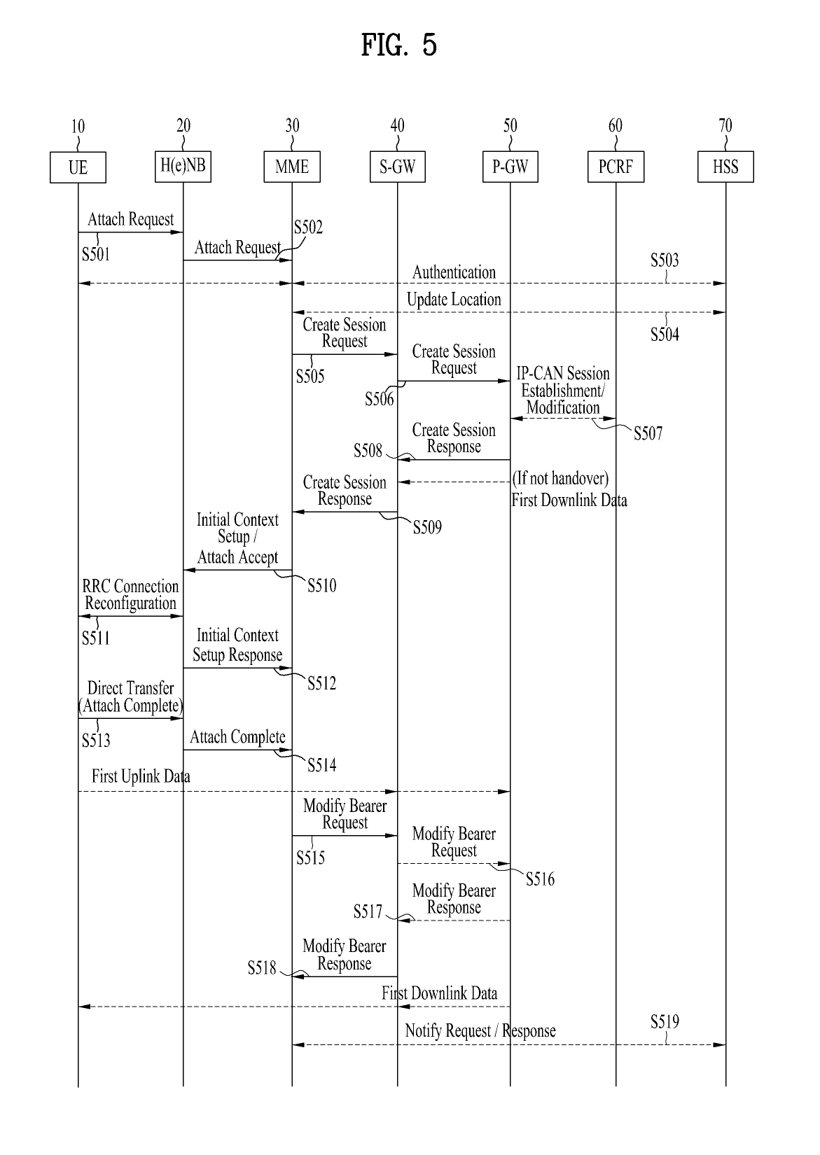

FIG. 5 is a flowchart for describing an initial attach operation for a 3GPP PDN connection via a H(e)NB.

The EPS initial attach procedure via a H(e)NB of FIG. 5 is basically the same as the EPS initial attach procedure via an eNB described above in relation to FIG. 4. That is, if an eNB in the description of FIG. 4 is replaced with a H(e)NB in FIG. 5, the descriptions of steps S401 to S419 of FIG. 4 may be equally applied to steps S501 to S519 of FIG. 5. The following description will be given of only parts added in the EPS initial attach procedure via a H(e)NB of FIG. 5, and parts repeated from the description of FIG. 4 will be omitted here.

In steps S501 and S502, if the UE 10 accesses via a CSG cell, a H(e)NB 20 may transmit an attach request message to the MME 30 by adding a CSG ID and a HeNB access mode to information received from the UE 10. A closed access mode can be assumed when the H(e)NB 20 does not send information about the access mode.

In steps S503 and S504, subscriber information stored in the HSS 70 may also include CSG subscription information. The CSG subscription information may include information about a CSG ID and an expiration time. The CSG subscription information may be additionally provided from the HSS 70 to the MME 30.

In steps S505 to S509, the MME 30 may perform access control based on the CSG subscription information and the H(e)NB access mode and then send a create session request message to the S-GW 40 to establish an EPS default bearer.

In step S510, if the UE 10 accesses via a hybrid cell, CSG membership status of the UE 10 may be included in an attach accept message such that the H(e)NB 20 can differentially control the UE 10 based on the corresponding information. Here, the hybrid access is a mixed form of closed access and open access and the hybrid cell basically serves all users like open access but still has characteristics of a CSG cell. That is, a subscriber belonging to a CSG can be served with higher priority compared to other users and can be charged additionally. This hybrid cell can be clearly distinguished from a closed cell for not providing access of users not belonging to a CSG.

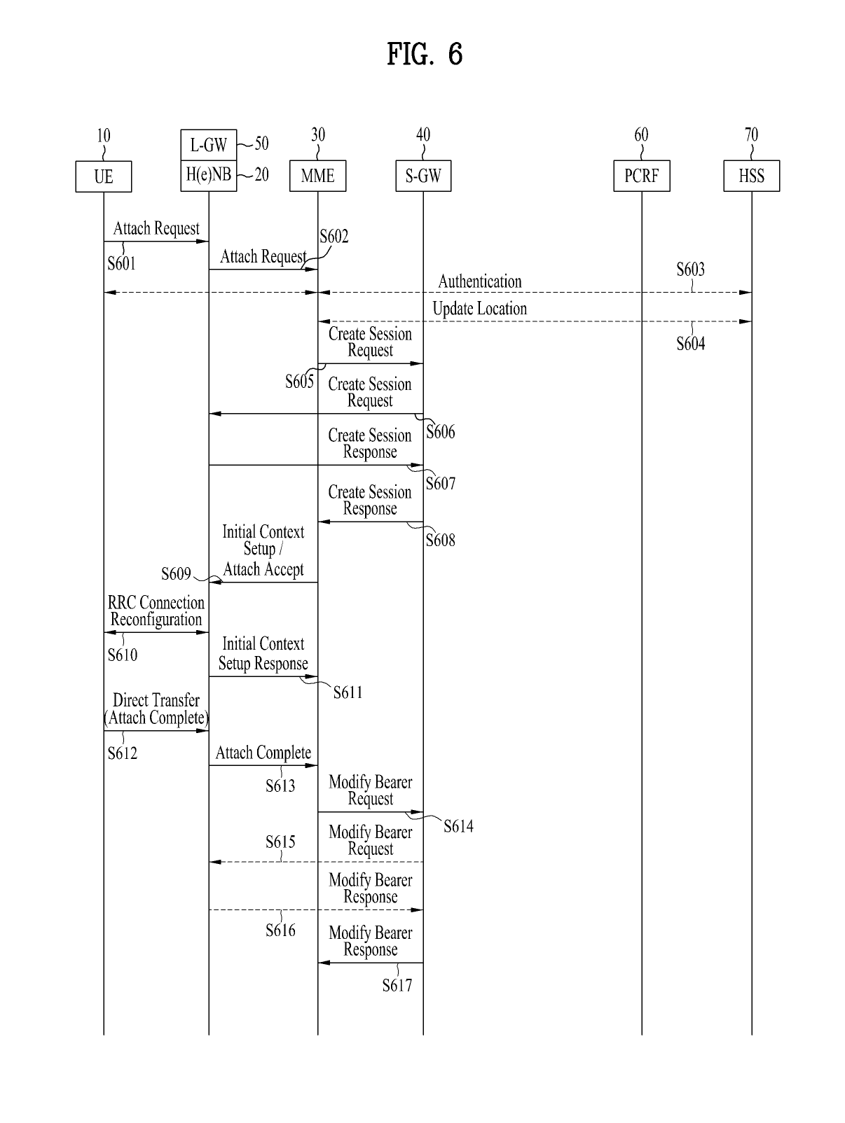

FIG. 6 is a flowchart for describing an initial attach operation for a LIPA PDN connection. Unlike FIGS. 4 and 5 illustrating EPS initial attach procedures, FIG. 6 corresponds to a LIPA initial attach procedure.

In steps S601 and S602, the UE 10 may send an attach request message via the H(e)NB 20 to the MME 30. In this case, the UE 10 may also send an APN of a PDN to which a connection is desired, together with the attach request. In the case of LIPA, a LIPA APN of a home based network may be sent as the APN. The H(e)NB 20 may transmit the attach request message to the MME 30 by adding a CSG ID, a HeNB access mode and an address of a co-located L-GW 50 to information received from the UE 10.

In steps S603 and S604, the MME 30 may perform an authentication procedure on the UE 10, and register location information of the UE 10 in the HSS 70. In this operation, the HSS 70 may transmit subscriber information of the UE 10 to the MME 30. The subscriber information stored in the HSS 70 may also include CSG subscription information and LIPA information. The CSG subscription information may include information about a CSG ID and an expiration time. The LIPA information may include indication information indicating whether LIPA is permitted to a corresponding PLMN and information about LIPA permission of a corresponding APN. As described above, LIPA permission may correspond to one of LIPA-prohibited, LIPA-only and LIPA-conditional. The CSG subscription information and the LIPA information may be additionally provided from the HSS 70 to the MME 30.

In steps S605 to S608, the MME 30 may perform evaluation for control of a CSG and a LIPA APN based on the CSG subscription information, the H(e)NB access mode and LIPA information. Evaluation may include CSG membership check, LIPA-permission check, etc. As a result of evaluation, if the UE 10 is permitted to access the LIPA APN via the H(e)NB 20, the MME 30 may send a create session request message to the S-GW 40 to establish an EPS default bearer. The S-GW 40 may send the create session request message to a P-GW. In the case of LIPA, the address of the L-GW 50 received from the H(e)NB 20 is used to select the P-GW. In response to this message, the P-GW (or the L-GW 50) may send a create session response message to the S-GW 40, and the S-GW 40 may send the create session response to the MME 30. Through these operations, the S-GW 40 and the P-GW (or the L-GW 50) may exchange TEIDs, and the MME 30 may recognize the TEIDs of the S-GW 40 and the P-GW (or the L-GW 50). In addition, the LIPA APN information may also be transmitted to the MME 30 together with the create session response message.

In the case of LIPA APN of LIPA-conditional, if the MME 30 has received information (e.g., address) about the L-GW 50 from the H(e)NB 20, a LIPA connection may be attempted. If the MME 30 has not received the information about the L-GW 50 from the H(e)NB 20, a P-GW selection function for a PDN connection may be performed.

In step S609, an attach accept message may be transmitted from the MME 30 to the H(e)NB 20. This message initiates radio resource setup in a RAN period (between the UE 10 and the H(e)NB 20) by requesting initial context setup. In this case, the above-described PDN connection type can indicate LIPA, and correlation ID information for a user plane direct link path between the H(e)NB 20 and the L-GW 50 may also be transmitted together with the attach accept message. The correlation ID corresponds to an ID of the L-GW 50, and a TEID of the P-GW may be provided as the ID of the L-GW 50 if the L-GW 50 serves as the P-GW.

In step S610, RRC connection reconfiguration is performed. As such, radio resources of the RAN period are set up and a result thereof may be transmitted to the H(e)NB 20.

In step S611, the H(e)NB 20 may transmit an initial context setup response message to the MME 30. A result of radio bearer setup may also be transmitted together with this message.

In steps S612 and S613, an attach complete message may be sent from the UE 10 via the H(e)NB 20 to the MME 30. In this case, the H(e)NB 20 may also send a TEID of the H(e)NB 20 for DL data together with this message.

In steps S614 to S617, a modify bearer request message may be transmitted from the MME 30 to the S-GW 40 and this message may deliver the TEID of the H(e)NB 20 for DL data to the S-GW 40. As optional operations, in steps S615 and S616, the bearer between the S-GW 40 and the P-GW (or the L-GW 50) may be updated as necessary.

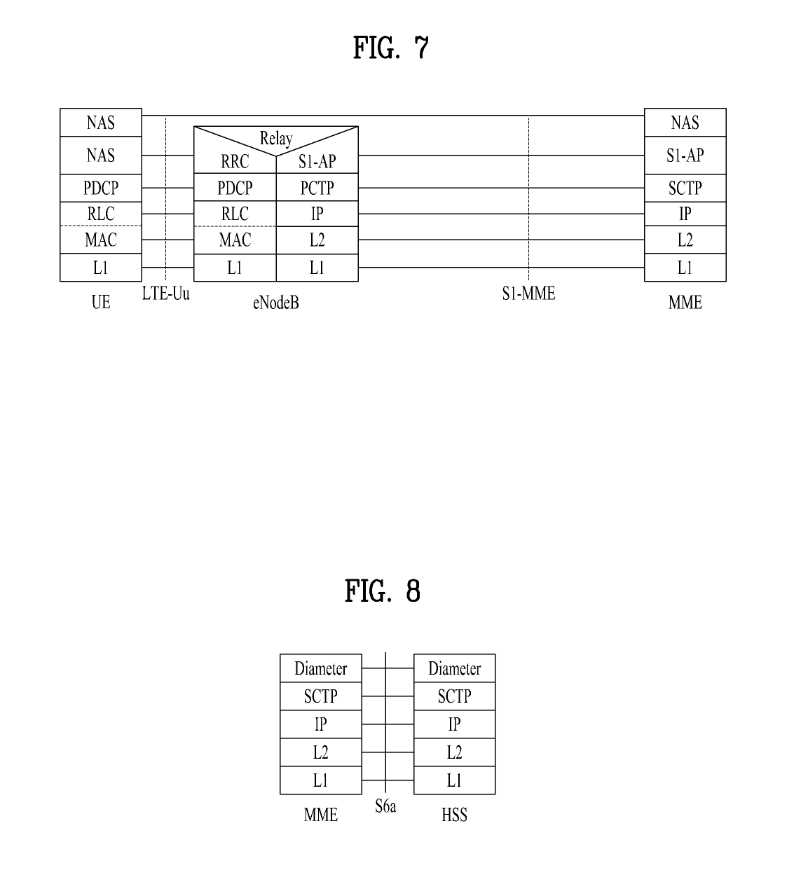

FIG. 7 is a view illustrating a control plane for interfaces among a UE, an eNB and an MME.

The MME may perform access control on the UE that attempts access, and interfaces and protocol stacks used therefor are as illustrated in FIG. 7. The interfaces illustrated in FIG. 7 correspond to those among the UE, the eNB and the MME in FIG. 2. Specifically, a control plane interface between the UE and the eNB is defined as LTE-Uu, and a control plane interface between the eNB and the MME is defined as S1-MME. For example, an attach request/response message between the eNB and the MME may be transmitted and received via the S1-MME interface using an S1-AP protocol.

FIG. 8 is a view illustrating a control plane for an interface between an MME and an HSS.

A control plane interface between the MME and the HSS is defined as S6a. The interface illustrated in FIG. 8 corresponds to that between the MME and the HSS in FIG. 2. For example, the MME may receive subscription information from the HSS via the S6a interface using a Diameter protocol.

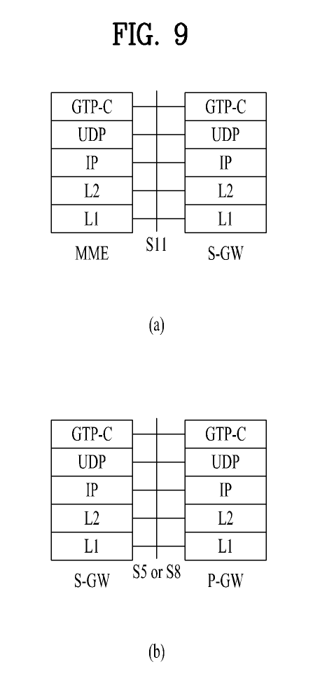

FIG. 9 is a view illustrating a control plane for interfaces among an MME, an S-GW and a P-GW.

A control plane interface between the MME and the S-GW is defined as S11 (FIG. 9(a)), and a control plane interface between the S-GW and the P-GW is defined as S5 (when not roamed) or S8 (when roamed) (FIG. 9(b)). The interfaces illustrated in FIG. 9 correspond to those among the MME, the S-GW and the P-GW in FIG. 2. For example, a request/response message for EPC bearer setup (or GTP (GPRS Tunneling Protocol) tunnel establishment) between the MME and the S-GW may be transmitted and received via the S11 interface using a GTP or GTPv2 protocol. In addition, a request/response message for bearer setup between the S-GW and the P-GW may be transmitted and received via the S5 or S8 interface using a GTPv2 protocol. The GTP-C protocol illustrated in FIG. 9 refers to a GTP protocol for a control plane.

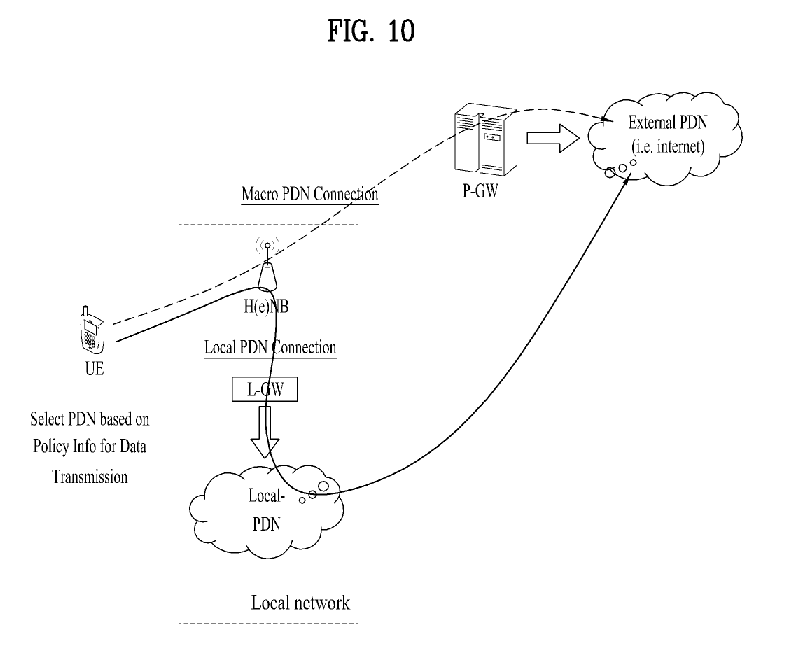

FIG. 10 is a view illustrating Selected IP Traffic Offload at Local Network (SIPTO@LN) in LTE/LTE-A. SIPTO@LN means to offload user traffic via a local network of the user. That is, as illustrated in FIG. 10, a UE may have a local PDN connection as well as a macro PDN connection, and may transmit data through one of the macro PDN and the local PDN based on policy information. SIPTO@LN in LTE/LTE-A is as described below. An MME/SGSN determines whether to perform SIPTO of a PDN based on SIPTO permission information of the PDN included in subscription information of the UE received from an HSS/SLR, location information of the UE received from an eNB/Home(e)NB, local configuration information, etc. Upon determining to perform SIPTO for the PDN, the MME/SGSN deletes the PDN and transmits a reactivation/deactivation cause value to the UE. The UE may request a PDN connection using the same APN to have a local PDN connection. Such SIPTO@LN may include per APN SIPTO@LN and per IP flow SIPTO@LN. Per APN SIPTO@LN is SIPTO performed on an APN basis, and per IP flow SIPTO@LN is SIPTO performed not on an APN basis but per IP flow selectively via a core network (P-GW) or a local network (L-GW). The UE previously receives policy information from the network and refers to the policy information for PDN selection to transmit data.

Above-described SIPTO does not support a plurality of PDN connections to different P-GWs. Furthermore, legacy per IP flow SIPTO@LN is applicable only when two PDN connections are available, that is, not applicable when two PDN connections are not established. This can cause a restriction when per IP flow SIPTO@LN needs to be performed based on, for example, network management policy of an operator.

In addition, in legacy SIPTO, per APN SIPTO@LN operates upon the determination of a network while per IP flow SIPTO@LN operates upon the determination of a UE. That is, since the two technologies are managed separately, appropriate load distribution cannot be achieved if two types of offloading simultaneously occur.

Accordingly, a description is now given of methods for solving the above problem.

### Embodiment 1

Embodiment 1 relates to a method for supporting per IP flow SIPTO@LN by establishing local network PDN connections through different PDNs.

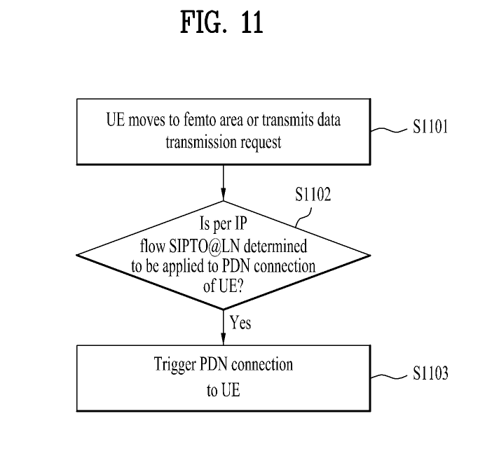

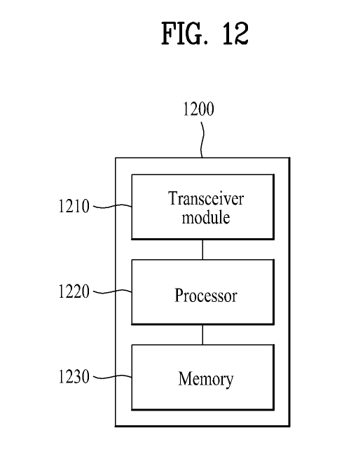

FIG. 11 is a flowchart of a method for supporting per IP flow SIPTO@LN by an MME/SGSN. Referring to FIG. 11, if a UE moves to a femto area or transmits a data transmission request in step S1101, the MME may determine whether to apply per IP flow SIPTO@LN to a PDN connection of the UE in step S1102. A condition for triggering the determination of whether to apply per IP flow SIPTO@LN in step S1101 may be inter-cell migration of a UE in an idle mode or a connected mode through Tracking Area Update (TAU) or handover, or a service request or a PDN connection request of the UE.

The MME may determine whether to apply per IP flow SIPTO@LN to the PDN connection of the UE in step S1102 based on location information of the UE transmitted from an (e)NB/Home(e)NB, SIPTO capability information transmitted from the (e)NB/Home(e)NB, SIPTO permission information of the PDN included in subscription information of the UE (transmitted from an HSS), and local configuration information. Here, the SIPTO permission information includes per APN SIPTO permission information, i.e., SIPTO Prohibited, SIPTO Allowed (excluding SIPTO@LN), SIPTO Allowed including SIPTO@LN, and SIPTO@LN Allowed only.

In addition, the MME according to the current embodiment of the present invention may further consider the following information to apply/determine per IP flow SIPTO@LN.

First, the SIPTO permission information included in the subscription information may include SIPTO Allowed including SIPTO@LN per IP flow).

Second, the local configuration information may include priority information for per APN and per IP flow. This information could have been recorded per PLMN, per MME/SGSN, and per local network.

Upon determining to apply per IP flow SIPTO@LN to the existing PDN connection of the UE based on the above-described information, the MME may trigger a new PDN connection for a local PDN connection to the UE in step S1103. Here, the new PDN connection may be triggered in the form of a NAS massage transmitted to the UE. The message associated with triggering may include a cause value or an APN associated with the local PDN connection. In this case, the UE can already have a local PDN connection.

If the UE already has a local PDN connection (e.g., if the UE has a local PDN connection for LIPA), the UE may use this local PDN connection for per IP flow SIPTO@LN. In this regard, the MME may add a new cause value or transmit an APN of an existing local PDN connection to the UE. That is, a notification or an indication may be provided in the form of a NAS message to the UE. As such, the UE may be aware that per IP flow SIPTO@LN is applicable using the local PDN connection for data transmission.

If the UE does not have such a local PDN connection, the MME may request the UE to establish a new local PDN connection for per IP flow SIPTO@LN. The MME adds a new cause value or transmits an APN of the local PDN connection to be newly established to the UE. In this case, an available APN may need the permission information of the subscriber information. If the UE receives only the cause value, an APN previously stored in the UE may be used. If the APN is also received, the UE may request a PDN connection using the received APN. The local PDN connection may be established after permission is given by a user.

If the UE has two PDN connections through the above procedure, the UE may transmit data by selecting a preferred APN based on policy information. Here, the preferred APN based on the policy information may be selected using a mechanism suggested by Operator Policy for IP Interface Selection (OPIIS). This mechanism is a mechanism for making a selection among established PDN connections, and thus may be combined and cooperate with the technology of the present invention.

Similarly to the above method, the UE may recognize such a situation and perform triggering/determination to request a PDN connection via a local network. In this case, the network makes a determination based on the above condition and permits the PDN connection if the condition is satisfied.

### Embodiment 2

Embodiment 2 follows the above-described procedure of Embodiment 1 but has a difference in that the same APN as an APN associated with an existing PDN connection of the UE is used to establish a local PDN connection. The MME/SGSN adds a new cause value such that the UE requests a PDN connection using the same APN. Since the MME/SGSN has an APN of a core network, the MME/SGSN allocates a GW of a local network to signal PDN connection permission to the UE. In this case, the UE should identify the two PDN connections, and an IP address received through an accept message or a new indicator may be used for identification. That is, the two PDNs use the same APN and thus cannot be identified by the APN, and the core network and the local network may be identified using IP addresses or indicators received from GWs thereof. For data transmission, policy information for a corresponding IP flow and a preferred path (the core network or the local network) should be received in advance. For example, information having a form of (source address, source port, target address target port, preferred path (CN/LN)) may be used.

### Embodiment 3

Embodiment 3 relates to a method for solving unbalanced load distribution which can be caused when per APN SIPTO@LN and per IP flow SIPTO@LN are independently managed as described above. In detail, per APN SIPTO is performed by removing a current PDN connection and allocating a new GW to establish a new PDN connection upon the determination of a network. On the other hand, per IP flow SIPTO may be performed by appropriately selecting one of a plurality of established PDN connections (e.g., core network and local network connections) based on an IP flow upon the determination of a UE. The problem is that an unexpected operation can be caused if two types of offloading simultaneously occur upon the determination of the network in the former case and upon the determination of the UE in the latter case. For example, per APN SIPTO may be performed when per IP flow SIPTO is enabled. A specific PDN connection can be reactivated as a connection via an opposite network and thus both PDN connections can be established via only one of the core network and the local network. In this case, signaling is wasted and PDN connection utilization efficiency is reduced. For example, when the UE has a PDN connection via a local network, the UE requests a new PDN connection and a PDN connection via the local network is allocated if a corresponding APN is capable of SIPTO@LN. Ultimately, the two PDN connections are established via the local network and thus the original purpose of per IP flow SIPTO cannot be achieved. In this regard, the existing local PDN connection should be reconfigured as a PDN connection via a core network. Accordingly, methods for appropriately controlling per APN SIPTO and per IP flow SIPTO are required to correctly manage PDN connections.

As a first method, the UE may signal the network that per IP flow SIPTO@LN is currently performed. In other words, when the UE performs per IP flow SIPTO@LN using policy information of the UE, the UE may signal this information to the network. In this case, the network determines whether to perform per APN SIPTO, in consideration of the signaled information. For example, when the UE moves to the local network, the network determines whether to perform per APN SIPTO. In this case, the network checks the information received from the UE and does not perform per APN SIPTO. As such, per IP flow SIPTO@LN may be continuously performed and resources may be efficiently managed. The above information may be requested together with transmission of a NAS message when the UE moves or is attached, or transmits a PDN connection request.

As a second method, the network may determine whether per IP flow SIPTO@LN is currently performed, as described below.

An operator provides policy for per IP flow SIPTO@LN to the UE. Accordingly, if the network is aware that the UE has the policy for per IP flow SIPTO@LN, the network may determine that per IP flow SIPTO@LN is currently performed. That is, if the network is aware that the UE has PDN connections via the local network and the core network and is additionally aware that the local network currently supports SIPTO@LN, the network may determine that per IP flow SIPTO@LN is currently performed. Furthermore, if both PDN connections are established via the local network as in the above example, a PDN connection capable of per APN SIPTO may be reconfigured as a connection via the core network. In this regard, an HSS signals subscriber information indicating that the UE has the policy for per IP flow SIPTO@LN. In addition, the network may check networks via which PDN connections are currently established, using subscriber information or context information. That is, the network may make a determination in consideration of APN type, SIPTO or LIPA permission, etc.

The above-described embodiments of the present invention may be implemented independently or two or more embodiments may be combined.

FIG. 12 is a block diagram of a transceiver apparatus 1200 according to embodiments of the present invention.

Referring to FIG. 12, the transceiver apparatus 1200 according to the embodiments of the present invention may include a transceiver module 1210, a processor 1220 and a memory 1230. The transceiver module 1210 may be configured to transmit and receive a variety of signals, data and information to and from an external device. The transceiver apparatus 1200 may be connected to the external device by wire and/or wirelessly. The processor 1220 may be configured to provide overall control to the transceiver apparatus 1200 and to process information to be transmitted to or received from the external device. The memory 1230 may store the processed information for a predetermined time and is replaceable by another component such as a buffer (not shown).

The transceiver apparatus 1200 according to an embodiment of the present invention may be configured to transmit SIPTO@LN indication information (or SIPTO@LN PDN connection indication information). The processor 1220 of the transceiver apparatus 1200 may be configured to generate SIPTO@LN PDN connection indication information about a PDN connection of a UE. Furthermore, the processor 1220 of the transceiver apparatus 1200 may be configured to transmit the SIPTO@LN PDN connection indication information through the transceiver module 1210 to the UE. Here, the SIPTO@LN PDN connection indication information may indicate whether the PDN connection of the UE is a SIPTO@LN PDN connection. In addition, the processor 1220 of the transceiver apparatus 1200 may be configured to transmit the SIPTO@LN PDN connection indication information through the transceiver module 1210 and a serving gateway node to a PDN gateway node.

The transceiver apparatus 1200 according to another embodiment of the present invention may be configured to receive SIPTO@LN indication information. The processor 1220 of the transceiver apparatus 1200 may be configured to receive SIPTO@LN PDN connection indication information indicating whether a PDN connection of a UE is a SIPTO@LN PDN connection, from a first network node (e.g., MME) through the transceiver module 1210. Here, the SIPTO@LN PDN connection indication information may be generated by the first network node.

The transceiver apparatus 1200 may be configured in such a manner that the above-described embodiments of the present invention are implemented independently or two or more embodiments are combined. Redundant descriptions are not given here for clarity.

The above-described embodiments of the present invention may be implemented by various means, for example, hardware, firmware, software, or a combination thereof.

In a hardware configuration, the methods according to embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to embodiments of the present invention may be implemented in the form of a module, a procedure, a function, etc. performing the above-described functions or operations. Software code may be stored in a memory unit and executed by a processor. The memory unit may be located inside or outside the processor and exchange data with the processor via various known means.

The detailed descriptions of the preferred embodiments of the present invention have been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

Those skilled in the art will appreciate that the present invention may be carried out in other specific ways than those set forth herein without departing from the spirit and essential characteristics of the present invention. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. Also, it will be obvious to those skilled in the art that claims that are not explicitly cited in the appended claims may be presented in combination as an exemplary embodiment of the present invention or included as a new claim by subsequent amendment after the application is filed.

### INDUSTRIAL APPLICABILITY

The above-mentioned embodiments of the present invention are applicable to a variety of mobile communication systems.

1. A method for supporting Selected IP Traffic Offload at Local Network (SIPTO@LN) by a network node in a wireless communication system, the method comprising:
determining whether to apply per IP flow SIPTO@LN to a Packet Data Network (PDN) connection associated with a first Access Point Name (APN); and
triggering a PDN connection associated with a second APN to a UE upon determining to apply per IP flow SIPTO@LN.

2. The method according to claim 1, wherein the determining is performed based on one or more of location information of the UE, SIPTO capability information, SIPTO permission information, and local configuration information.

3. The method according to claim 1, wherein the SIPTO permission information comprises per IP flow SIPTO permission information at the local network.

4. The method according to claim 1, wherein the SIPTO permission information further comprises per APN SIPTO permission information.

5. The method according to claim 1, wherein the per APN SIPTO permission information comprises SIPTO Prohibited, SIPTO Allowed (excluding SIPTO@LN), SIPTO Allowed including SIPTO@LN, and SIPTO@LN Allowed only.

6. The method according to claim 1, wherein the local configuration information comprises priority information for per APN SIPTO and per IP flow SIPTO.

7. The method according to claim 1, wherein the triggering of the PDN connection comprises transmitting a message comprising at least one of a cause value and the second APN.

8. The method according to claim 7, wherein, if the UE already has a PDN connection via the local network, the message indicates that per IP flow SIPTO is enabled using the PDN connection of the UE.

9. The method according to claim 7, wherein, if the UE does not have a PDN connection via the local network, the message indicates establishment of the PDN connection via the local network to perform per IP flow SIPTO.

10. The method according to claim 1, wherein the determining is performed if the UE moves to a preset area.

11. The method according to claim 1, wherein the determining is performed upon one of a service request and a PDN request of the UE.

12. The method according to claim 1, wherein the first APN and the second APN are different from each other.

13. The method according to claim 1, wherein the network node is one of a Mobility Management Entity (MME) and a Serving GPRS (General Packet Radio Service) Support Node (SGSN).

14. A network node for supporting Selected IP Traffic Offload at Local Network (SIPTO@LN) by a network node in a wireless communication system, the network node comprising:
a transceiver module; and
a processor,
wherein the processor is configured to determine whether to apply per IP flow SIPTO@LN to a Packet Data Network (PDN) connection associated with a first Access Point Name (APN), and to trigger a PDN connection associated with a second APN to a UE upon determining to apply per IP flow SIPTO@LN.
